(19) United States
(12) Patent Application Publication
(10) Pub. No.: US 2020/0362124 A1
(43) Pub. Date: Nov. 19, 2020

(54) COMPOSITE MATERIAL COMPRISING METALLIC WIRES AND METHOD FOR FABRICATION THEREOF

(71) Applicant: QinetiQ Limited, Hampshire (GB)

(72) Inventors: Charlotte Bree MEEKS, Hampshire (GB); Andrew David FOREMAN, Hampshire (GB); Abdul-Salam KADDOUR, Hampshire (GB)

(21) Appl. No.: 16/966,815

(22) PCT Filed: Jan. 28, 2019
(86) PCT No.: PCT/EP2019/051969

§ 371 Date: Jul. 31, 2020

(30) Foreign Application Priority Data
Feb. 1, 2018 (GB) 1801652.7

(51) Int. Cl. C08J 5/04; C08J 5/24

(52) U.S. Cl. CPC C08J 5/047; C08J 5/24; C08J 2333/08; C08J 2367/00; C08J 2363/00; C08J 2375/04; C08J 2339/00

(57) ABSTRACT

Some embodiments are directed to a composite material comprising a polymer matrix having reinforcing fibres and metallic wires embedded therein, articles including the composite material and methods of fabrication of the composite material and articles.

### CROSS REFERENCE TO RELATED APPLICATION(S)

This application is a national phase filing under 35 C.F.R. § 371 of and claims priority to PCT Patent Application No. PCT/EP2019/051969, filed on Jan. 28, 2019, which claims the priority benefit under 35 U.S.C. § 119 of British Patent Application No. 1801652.7, filed on Feb. 1, 2018, the contents of each of which are hereby incorporated in their entireties by reference.

### BACKGROUND

Some embodiments relate generally to the use of metallic wires to enhance or improve the impact performance and/or penetration resistance of composite materials including a polymer matrix with reinforcing fibres embedded therein. The present inventors have surprisingly and advantageously found that certain metallic wires, for example having a certain stress-strain curve, are particularly useful for enhancing or improving the impact performance and/or penetration resistance of composite materials. Thus, some embodiments also relate to composite materials including a polymer matrix with reinforcing fibres and metallic wires embedded therein, and methods for selecting metallic wires to enhance or improve the impact performance and/or penetration resistance of a composite material including a polymer matrix with reinforcing fibres embedded therein.

Composite materials having a high strength to weight ratio and a good resistance to impact damage may be made by embedding relatively high modulus fibres together with shape memory alloy (SMA) wires in a relatively low modulus polymer matrix mix. These materials are particularly useful in many aerospace, automotive and marine applications, in particular for articles that may be vulnerable to impact damage (e.g., by tool drop, runway debris or bird strike). It is desirable to understand the properties of the SMA wires that contribute to the advantageous impact performance of the composite material so that composite materials having a particularly desirable (e.g., enhanced or improved or alternative) impact performance can be made. It is also desirable to identify other wires other than SMA wires that may be used in composite materials to provide an advantageous impact performance.

### SUMMARY

Some embodiments provide a composite material including a polymer matrix with reinforcing fibres and metallic wires embedded therein, wherein the metallic wires have a stress-strain curve such that:
a) the initial modulus of the metallic wire is less than the initial modulus of a baseline composite material including the polymer matrix with the reinforcing fibres embedded therein;
b) the strain at which the stress-strain curve of the metallic wire starts to plateau is greater than the maximum strain of the baseline composite material; and
c) the total area under the stress-strain curve of the metallic wire is at least ten times the total area under the stress-strain curve of the baseline composite material; and
   wherein the metallic wires are in a passive state.

Some other embodiments provide a method for selecting a metallic wire to enhance or improve the impact performance and/or penetration resistance of a composite material including a polymer matrix with reinforcing fibres embedded therein, the method including determining the stress-strain curve of the composite material and selecting a metallic wire having a stress-strain curve such that:
a) the initial modulus of the metallic wire is less than the initial modulus of the composite material;
b) the strain at which the stress-strain curve of the metallic wire starts to plateau is greater than the maximum strain of the composite material; and
c) the total area under the stress-strain curve of the metallic wire is at least ten times the total area under the stress-strain curve of the composite material; and
   wherein the metallic wire is in a passive state.

Some other embodiments provide a use of metallic wires to enhance or improve the impact performance and/or penetration resistance of a composite material including a polymer matrix with reinforcing fibres embedded therein, wherein the metallic wires are embedded in the polymer matrix and wherein the metallic wires have a stress-strain curve such that:
a) the initial modulus of the metallic wire is less than the initial modulus of the composite material;
b) the strain at which the stress-strain curve of the metallic wire starts to plateau is greater than the maximum strain of the composite material; and
c) the total area under the stress-strain curve of the metallic wire is at least ten times the total area under the stress-strain curve of the composite material; and
wherein the metallic wires are in a passive state.

Some other embodiments provide an article including a composite material including a polymer matrix with reinforcing fibres and metallic wires embedded therein. The composite material may, for example, be in accordance with any aspect or embodiment disclosed herein. The article may, for example, be an aircraft structural component.

Some other embodiments provide a use of a composite material including a polymer matrix with reinforcing fibres and metallic wires embedded therein to manufacture an article, for example an aircraft structural component.

Some other embodiments provide a method for manufacturing a composite material including a polymer matrix with reinforcing fibres and metallic wires embedded therein.

Some other embodiments provide a preform including reinforcing fibres and metallic wires, wherein the preform is suitable for and/or intended for use in a composite material including a polymer matrix with the preform embedded therein. The composite material may, for example, be in accordance with any aspect or embodiment disclosed herein.

Certain embodiments of any aspect of some embodiments may provide one or more of the following advantages:
good impact performance;
good penetration resistance;
good inter-laminar properties (e.g. good inter-laminar shear strength and strain);
ability to make complex 3D structures in a single piece and process to near net shape;
good flexural modulus;
good compressive strength;
highly porous which may, for example, decrease resin fusion time;
decreased crimping of reinforcing fibres and/or SMA wires;
stable to processing techniques (e.g. weaving, curing etc.);
multifunctional properties.

The details, examples and preferences provided in relation to any particular one or more of the stated aspects of some embodiments will be further described herein and apply equally to all or most aspects of some embodiments. Any combination of the embodiments, examples and preferences described herein in all or most possible variations thereof is encompassed by some embodiments unless otherwise indicated herein, or otherwise clearly contradicted by context.

### BRIEF DESCRIPTION OF THE FIGURES

Aspects of some embodiments will be described in more detail, with reference to the appended drawings showing embodiment(s) of the presently disclosed subject matter.

FIG. 1 shows exemplary stress-strain curves for a composite material having reinforcing fibres embedded therein (dotted line) and a metallic wire (solid line);

FIGS. 2a, 2b and 2c show cross sectional illustrations of embodiments of the composite material in accordance with some embodiments as single ply (plan and side views) and two ply (plan view) respectively.

FIG. 3 shows a preform material in accordance with some embodiments of the presently disclosed subject matter in the form of a non crimp fabric possessing four layers and thus showing an example of a quadriaxial fabric.

FIG. 4(a) shows an example of a plain pattern in a 2D woven material.

FIG. 4(b) shows an example of a twill pattern in a 2D woven material.

FIG. 4(c) shows an example of a satin pattern in a 2D woven material.

FIG. 4(d) shows an example of a triaxial woven pattern in a 2D woven material.

FIG. 5(a) shows an example a biaxial braided pattern in a 2D braided material.

FIG. 5(b) shows an example of a triaxial braided pattern in a 2D braided material.

FIG. 6 shows an example of a knitted pattern.

FIG. 7(a) shows an example of a 3D orthogonal weave material.

FIG. 7(b) shows an example of a 3D angle-interlock weave material.

FIG. 7(c) shows an example of a 3D layer-to-layer weave material.

FIG. 8 is a schematic diagram illustrating tufting.

FIG. 9 shows an exemplary method of z-pinning in which A is the uncured stack of layers of reinforced fibres and/or SMA wires, B is the z-pin preform and C is an ultrasonic hammer.

FIG. 10(a) shows an example of a fully-interlaced plain woven material.

FIG. 10(b) shows an example of a fully-interlaced twill woven material.

FIG. 10(c) shows an example of a fully-interlaced satin woven material.

FIG. 11 shows an example of a fully-interlaced braided material.

FIG. 12 shows an example of a pattern of a fully-interlaced knitted material.

FIG. 13 shows the stress-strain curve of two different Ti—Ni SMA wires.

FIG. 14 shows the penetration resistance of different composite panels having SMA reinforced plys in different locations through the panel.

FIG. 15 shows the stress-strain curve of the AS4/8552 composite material, a round SMA wire of alloy M, a round SMA wire of alloy C and an oval SMA wire of alloy C.

FIG. 16 shows the stress-strain curve of an SMA wire of alloy M after various thermal cycles and heat-treatments.

FIG. 17 shows the stress-strain curve of an SMA wire of alloy M after exposure to a typical epoxy cure cycle and after heat treatment to 400° C. and holding for 2 hours compared to the stress-strain curve of an SMA wire of alloy M that has not been heat treated.

### DETAILED DESCRIPTION OF EXEMPLARY EMBODIMENTS

Some embodiments may be described with reference to the accompanying drawings, in which currently preferred embodiments of the presently disclosed subject matter are shown. This presently disclosed subject matter may, however, be embodied in many different forms and should not be construed as limited to the embodiments set forth herein; rather, these embodiments are provided for thoroughness and completeness, and fully convey the scope of the presently disclosed subject matter to one of ordinary skill in the art.

The present inventors have surprisingly and advantageously found that metallic wires having certain characteristics provide a particularly enhanced or improved impact performance and/or penetration resistance. This has enabled the provision of composite materials including a polymer matrix with reinforcing fibres and metallic wires embedded therein, methods for selecting a metallic wire to enhance or improve the impact performance and/or penetration resistance of a composite material and the use of metallic wires to enhance or improve the impact performance and/or penetration resistance of a composite material disclosed herein.

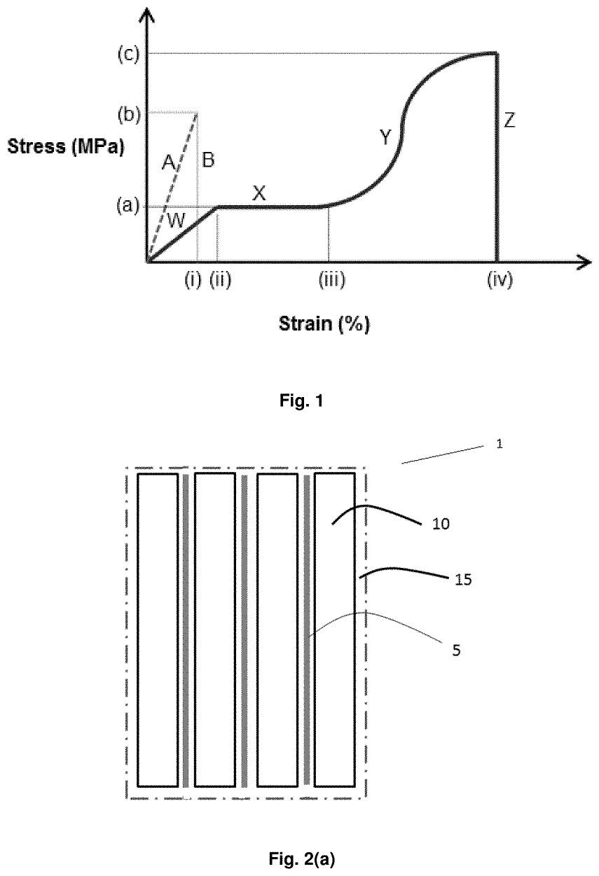

The characteristics that provide a particularly enhanced or improved impact performance and/or penetration resistance may be defined by referring to the particular curves that arise when stress (y-axis) is plotted against strain (x-axis) for both the metallic wires and the composite material into which the metallic wires are to be incorporated (i.e. the composite material without any metallic wires). The stress-strain curve of the metallic wires refers to the measurements obtained from a single metallic wire of the type to be incorporated into the composite material. The stress-strain curves may, for example, be plotted after testing at a defined temperature that is less than the Austenitic transformation temperature of the metallic wire. The Austenitic transformation temperature of the metallic wire may, for example, range from about 40° C. to about 70° C. Thus, the stress-strain curve may be plotted after testing at equal to or less than about 70° C. or equal to or less than about 40° C. For example, the stress-strain curve may be plotted after testing at a temperature ranging from about 20° C. to about 25° C. In certain embodiments, the composite material into which the metallic wires are to be incorporated may exhibit a linear behaviour (as shown by A in FIG. 1) before reaching its failure strain (as shown by B in FIG. 1). The metallic wires initially exhibit a linear behaviour (as shown by Win FIG. 1) before reaching a plateau (as shown by X in FIG. 1). In certain embodiments, the metallic wire may then start to exhibit a linear or non-linear behaviour again (as shown by Y in FIG. 1) before reaching its failure strain (as shown by Z in FIG. 1).

The composite material into which the metallic wires are to be incorporated includes a polymer matrix having reinforcing fibres embedded therein. The composite material into which the metallic wires are to be incorporated may include all or most of the components of the final composite material except the metallic wires. In certain embodiments, the composite material into which the metallic wires are to be incorporated can include or may consist essentially of or consist of polymer matrix having reinforcing fibres embedded therein. The term “consisting essentially of” excludes any additional element, step or ingredient not explicitly recited unless the additional element, step or ingredient does not materially affect the basic and novel properties of the presently disclosed subject matter. Where the one or more additional element(s), step(s) or ingredient(s) is/are one or more additional component(s) of a composition, the total amount of the additional component(s) in the composition may, for example, be limited to 10 vol %. For example, the total amount of the additional component(s) in the composition may be limited to 9 wt % or 8 wt % or 7 wt % or 6 wt % or 5 wt % or 4 wt % or 3 wt % or 2 wt % or 1 wt %. The composite material into which the metallic wires are to be incorporated may, for example, be referred to as the baseline composite material.

Firstly, the initial modulus of the metallic wires is less than the initial modulus of the composite material into which the metallic wires are to be incorporated. The modulus refers to the gradient of the slope of the stress-strain curve. The initial modulus refers to the gradient of the first slope of the stress-strain curve where the stress-strain curves include more than one slope. This is demonstrated in FIG. 1 as the slope A of the stress-strain curve of the composite material is steeper than slope W of the stress-strain curve of the metallic wire. The initial modulus of the metallic wires being less than the initial modulus of the composite material into which the metallic wires are to be incorporated means that the metallic wires do not add appreciable stiffness to the composite material.

In certain embodiments, the initial modulus of the metallic wires is at least about 20% less than the initial modulus of the composite material. For example, the initial modulus of the metallic wires may be at least about 25% or at least about 30% or at least about 35% or at least about 40% or at least about 45% or at least about 50% less than the initial modulus of the composite material.

In certain embodiments, the initial modulus of the metallic wires is up to about 80% less than the initial modulus of the composite material. For example, the initial modulus of the metallic wires may be up to about 75% less or up to about 70% less or up to about 65% less or up to about 60% less or up to about 55% less than the initial modulus of the composite material. For example, the initial modulus of the metallic wires may be from about 20% to about 80% or from about 30% to about 70% or from about 40% to about 60% or from about 45% to about 55% less than the initial modulus of the composite material.

The initial modulus of the metallic wires may, for example, be equal to or greater than about 20 GPa. For example, the initial modulus of the metallic wires may be equal to or greater than about 21 GPa or equal to or greater than about 22 GPa or equal to or greater than about 23 GPa or equal to or greater than about 24 GPa or equal to or greater than about 25 GPa. The initial modulus of the metallic wires may, for example, be equal to or less than about 35 GPa. For example, the initial modulus of the metallic wires may be equal to or less than about 34 GPa or equal to or less than about 33 GPa or equal to or less than about 32 GPa or equal to or less than about 32 GPa or equal to or less than about 31 GPa or equal to or less than about 30 GPa or equal to or less than about 29 GPa or equal to or less than about 28 GPa or equal to or less than about 27 GPa or equal to or less than about 26 GPa. For example, the initial modulus of the metallic wires may range from about 20 GPa to about 35 GPa or from about 20 GPa to about 30 GPa or from about 22 GPa to about 28 GPa or from about 23 GPa to about 27 GPa.

Secondly, the strain at which the stress-strain curve of the metallic wire starts to plateau is greater than the maximum strain of the composite material into which the metallic wires are to be incorporated. This means that the metallic wire does not exceed its initial modulus in normal use of the composite material (i.e. within the strain levels that the composite material is designed to withstand). The start of the plateau of the stress-strain curve of the metallic wire is defined by the point at which the gradient of stress-strain curve decreases and the slope of the curve starts to become near to or horizontal until a gradient that is at least about 50% lower than the gradient of the initial slope of the stress-strain curve (the modulus) is reached, for example until a gradient that is at least about 60% lower or 70% lower or 80% lower or 90% lower or 95% lower is reached. For example, the start of the plateau of the stress-strain curve of the metallic wire may be defined by the point at which the gradient of the stress-strain curve decreases and a gradient of 0 is reached. This is labelled (ii) in FIG. 1. The maximum strain of the composite material refers to the maximum tensile strain that can be exerted on the composite material before it fails (the failure strain of the composite material). This is labelled (i) in FIG. 1. The strain at which the stress-strain curve starts to plateau ((ii) in FIG. 1) is greater than the maximum strain of the composite material ((i) in FIG. 1).

In certain embodiments, the strain at which the stress-strain curve of the metallic wire starts to plateau is at least about 0.05% greater than the maximum strain of the composite material into which the metallic wires are to be incorporated. In certain embodiments, the strain at which the stress-strain curve of the metallic wire starts to plateau is at least about 0.1% greater or at least about 0.15% greater or at least about 0.2% greater or at least about 0.25% greater or at least about 0.3% greater or at least about 0.35% greater or at least about 0.4% greater or at least about 0.45% greater or at least about 0.5% greater than the maximum strain of the composite material into which the metallic wires are to be incorporated.

In certain embodiments, the strain at which the stress-strain curve of the metallic wire starts to plateau is up to about 2% greater than the maximum strain of the composite material into which the metallic wires are to be incorporated. In certain embodiments, the strain at which the stress-strain curve of the metallic wire starts to plateau is up to about 1.5% or up to about 1% or up to about 0.5% greater than the maximum strain of the composite material into which the metallic wires are to be incorporated. For example, the strain at which the stress-strain curve of the metallic wire starts to plateau may be from about 0.05% to about 2% or from about 0.1% to about 1% or from about 0.1% to about 0.5% greater than the maximum strain of the composite material into which the metallic wires are to be incorporated.

In certain embodiments, the strain at which the stress-strain curve of the metallic wire starts to plateau is equal to or greater than about 0.5%. For example, the strain at which the stress-strain curve of the metallic wire starts to plateau may be equal to or greater than about 0.6% or equal to or greater than about 0.7% or equal to or greater than about 0.8% or equal to or greater than about 0.9% or equal to or greater than about 1% or equal to or greater than about 1.1% or equal to or greater than about 1.2% or equal to or greater than about 1.3% or equal to or greater than about 1.4% or equal to or greater than about 1.5%. In certain embodiments, the strain at which the stress-strain curve of the metallic wire starts to plateau is equal to or less than about 2.5%, for example equal to or less than about 2.4% or equal to or less than about 2.3% or equal to or less than about 2.2% or equal to or less than about 2.1% or equal to or less than about 2% or equal to or less than about 1.9% or equal to or less than about 1.8% or equal to or less than about 1.7% or equal to or less than about 1.6%. For example, the strain at which the stress-strain curve of the metallic wire starts to plateau may range from about 0.5% to about 2.5% or from about 1% to about 2%.

In certain embodiments, the strain at which the plateau of the stress-strain curve of the metallic wire ends is equal to or greater than about 4%. The end of the plateau refers to the point at which the gradient of the curve starts to increase to form a second slope. In FIG. 1 the end of the plateau of the stress-strain curve of the metallic wire is labelled (iii) as the gradient of the curve starts to increase to form a second slope labelled Y. In certain embodiments, the strain at which the plateau of the stress-strain curve of the metallic wire ends is equal to or greater than about 4.1% or equal to or greater than about 4.2% or equal to or greater than about 4.3% or equal to or greater than about 4.4% or equal to or greater than about 4.5% or equal to or greater than about 4.6% or equal to or greater than about 4.5% or equal to or greater than about 4.6% or equal to or greater than about 4.7% or equal to or greater than about 4.8% or equal to or greater than about 4.9% or equal to or greater than about 5%. In certain embodiments, the strain at which the plateau of the stress-strain curve of the metallic wire ends is equal to or less than about 7%. In certain embodiments, the strain at which the plateau of the stress-strain curve of the metallic wire ends is equal to or less than about 6.9% or equal to or less than about 6.8% or equal to or less than about 6.7% or equal to or less than about 6.6% or equal to or less than about 6.5% or equal to or less than about 6.4% or equal to or less than about 6.3% or equal to or less than about 6.2% or equal to or less than about 6.1% or equal to or less than about 6%. In certain embodiments, the strain at which the plateau of the stress-strain curve of the metallic wire ends ranges from about 4% to about 7% or from about 4.5% to about 6.5% or from about 5% to about 6%.

In certain embodiments, the stress at which the start of the plateau of the stress-strain curve of the metallic wire occurs is less than the maximum stress of the composite material into which the metallic wires are to be incorporated. The maximum stress of the composite material refers to the maximum stress that is experienced by the composite material before it fails (the failure stress of the composite material by fibre failure). The stress at which the start of the plateau of the stress-strain curve of the metallic wire occurs is labelled (a) in FIG. 1. The maximum stress of the composite material is labelled (b) in FIG. 1 and is greater than (a).

In certain embodiments, the stress at which the start of the plateau of the stress-strain curve of the metallic wire occurs is at least about 200 MPa less than the maximum stress of the composite material. In certain embodiments, the stress at which the start of the plateau of the stress-strain curve of the metallic wire occurs is at least about 250 MPa or at least about 300 MPa or at least about 350 MPa or at least about 400 MPa or at least about 500 MPa or at least about 550 MPa or at least about 600 MPa or at least about 650 MPa or at least about 700 MPa or at least about 750 MPa or at least about 800 MPa or at least about 850 MPa or at least about 900 MPa or at least about 950 MPa or at least about 1000 MPa less than the maximum stress of the composite material. In certain embodiments, the stress at which the start of the plateau of the stress-strain curve occurs is up to about 2000 MPa or up to about 1900 MPa or up to about 1800 MPa or up to about 1700 MPa or up to about 1600 MPa or up to about 1500 MPa or up to about 1400 MPa less than the maximum stress of the composite material.

In certain embodiments, the plateau of the stress-strain curve (e.g. where the gradient of the curve is 0) occurs at a stress equal to or greater than about 100 MPa. For example, the plateau of the stress-strain curve may occur at a stress equal to or greater than about 110 MPa or equal to or greater than about 120 MPa or equal to or greater than about 130 MPa or equal to or greater than about 140 MPa or equal to or greater than about 150 MPa or equal to or greater than about 160 MPa or equal to or greater than about 170 MPa or equal to or greater than about 180 MPa or equal to or greater than about 190 MPa or equal to or greater than about 200 MPa. In certain embodiments, the plateau of the stress-strain curve occurs at a stress equal to or less than about 350 MPa. For example, the plateau of the stress-strain curve may occur at a stress equal to or less than about 340 MPa or equal to or less than about 330 MPa or equal to or less than about 320 MPa or equal to or less than about 310 MPa or equal to or less than about 300 MPa or equal to or less than about 290 MPa or equal to or less than about 280 MPa or equal to or less than about 270 MPa or equal to or less than about 260 MPa or equal to or less than about 250 MPa. For example, the plateau of the stress-strain curve may occur at a stress ranging from about 150 MPa to about 300 MPa or from about 170 MPa to about 280 MPa or from about 180 MPa to about 250 MPa.

Thirdly, the total area under the stress-strain curve of the metallic wire is at least about ten times greater than the total area under the stress-strain curve of the composite material into which the metallic wire is to be incorporated. This means that the metallic wires are able to absorb a much greater amount of energy than the composite material into which the metallic wires are to be incorporated. For example, the total area under the stress-strain curve of the metallic wire may be at least about eleven times or at least about twelve times or at least about thirteen times or at least about fourteen times or at least about fifteen times greater than the total area under the stress-strain curve of the composite material into which the metallic wire is to be incorporated.

In certain embodiments, the total area under the stress-strain curve of the metallic wire may be up to about fifty times greater than the total area under the stress-strain curve of the composite material into which the metallic wire is to be incorporated. For example, the total area under the stress-strain curve of the metallic wire may be up to about forty-five or up to about forty or up to about thirty-five or up to about thirty or up to about twenty-five or up to about twenty times greater than the total area under the stress-strain curve of the composite material into which the metallic wire is to be incorporated. For example, the total area under the stress-strain curve of the metallic wire may be from about three to about fifty or from about five to about twenty-five or from about ten to about twenty times greater than the total area under the stress-strain cure of the composite material into which the metallic wire is to be incorporated.

The total area under the stress-strain curve approximately corresponds to the total amount of energy absorbed by the material per unit volume. In certain embodiments, the total energy absorbed by a metallic wire referred to herein is equal to or greater than about 50 MJ/m³. For example, the total energy absorbed by the metallic wires may be equal to or greater than about 60 MJ/m³ or equal to or greater than about 70 MJ/m³ or equal to or greater than about 80 MJ/m³ or equal to or greater than about 90 MJ/m³ or equal to or greater than about 100 MJ/m³. In certain embodiments, the total energy absorbed by a metallic wire referred to herein may be up to about 200 MJ/m³. For example, the total energy absorbed by the metallic wires may be up to about 180 MJ/m³ or up to about 160 MJ/m³ or up to about 150 MJ/m³ or up to about 140 MJ/m³ or up to about 120 MJ/m³.

In addition, the metallic wires are in a passive state. This means that, contrary to metallic wires in an active state, the metallic wires do not change shape in response to a change in temperature under normal operating loads for the composite structure (i.e. applied strain of less than 1%).

In certain embodiments, the maximum strain of the metallic wires is equal to or greater than about 14%. The maximum strain of the metallic wire is the maximum strain that can be exerted on the metallic wire before failure (wire rupture) and is labelled (iv) on FIG. 1. For example, the maximum strain of the metallic wires may be equal to or greater than about 15% or equal to or greater than about 16% or equal to or greater than about 17% or equal to or greater than about 18% or equal to or greater than about 19% or equal to or greater than about 20%. In certain embodiments, the maximum strain of the metallic wires is equal to or less than about 20%. For example, the maximum strain of the metallic wires may be equal to or less than about 19% or equal to or less than about 18% or equal to or less than about 17% or equal to or less than about 16% or equal to or less than about 15%. For example, the maximum strain of the metallic wire may range from about 14% to about 20% or from about 15% to about 18% or from about 16% to about 17%.

In certain embodiments, the maximum stress of the metallic wires is equal to or greater than about 1200 MPa. The maximum stress of the metallic wire refers to the maximum stress that is experienced by the metallic wire before it fails (the failure stress of the metallic wire) and is labelled (c) on FIG. 1. For example, the maximum stress of the metallic wire may be equal to or greater than about 1300 M Pa or equal to or greater than about 1400 M Pa or equal to or greater than about 1500 MPa or equal to or greater than about 1600 MPa or equal to or greater than about 1700 MPa or equal to or greater than about 1800 MPa or equal to or greater than about 1900 MPa or equal to or greater than about 2000 MPa. In certain embodiments, the maximum stress of the metallic wire is equal to or less than about 2000 MPa. For example, the maximum stress of the metallic wire is equal to or less than about 1900 MPa or equal to or less than about 1800 MPa or equal to or less than about 1700 MPa or equal to or less than about 1600 M Pa or equal to or less than about 1500 M Pa. For example, the maximum stress of the metallic wire may range from about 1200 MPa to about 2000 MPa or from about 1400 MPa to about 1800 MPa.

### Arrangement of the Metallic Wires and Reinforcing Fibres

The metallic wires and reinforcing fibres may, for example, be arranged in a single ply (layer) or in two or more plys (layers). The terms ply and layer may be used interchangeably herein. Each ply may independently be one-dimensional (1D), two-dimensional (2D) or three-dimensional (3D). In certain embodiments, all or most plies in the composite material or preform that is used to make the composite material may be 1D or all or most plies in the composite material or preform may be 2D or all or most plies in the composite material or preform may be 3D. Where the plies are 3D, the composite material or preform used to make the composite material may preferably include a single ply. In certain embodiments, all or most the plies in the composite material or preform that is used to make the composite material are preferably unidirectional.

Each ply may independently include metallic wires and/or reinforcing fibres. Where the composite material or preform used to make the composite material disclosed herein includes only a single ply, the ply includes at least metallic wires and reinforcing fibres.

The orientation of the plies relative to each other may be such so as to achieve the desired in-plane performance.

In the composite materials and preforms described herein, the metallic wires and/or reinforcing fibres may be held together by one or more stabilising threads, for example a light weight stabilising thread. In certain embodiments, the stabilising thread holds together the metallic wires and/or reinforcing fibres within a single ply. In certain embodiments, the stabilising thread holds together two or more plies.

The stabilising thread may, for example, can include or can consist of, or include, a polymer such as polyester. The stabilising thread may, for example, be a thermoplastic thread such as a polyester thread. The stabilising thread may, for example, be an aramid thread such as Kevlar®. A stabilising thread is thread that does not affect the reinforcing or impact properties of the composite material or preform.

### One-Dimensional Plies

One-dimensional (1D) refers to plies in which the metallic wires and/or reinforcing fibres are not interlaced (e.g. woven) together in any way. This means that they do not cross and are not intricately linked together. Thus, in certain embodiments, the composite materials and preforms described herein include metallic wires and reinforcing fibres that are not woven together.

The metallic wires and/or reinforcing fibres may, for example, alternatively or additionally be described as being unidirectional (UD) in that they are arranged in the same direction. Thus, in certain embodiments, the composite materials and preforms described herein include unidirectional metallic wires and/or reinforcing fibres.

A stabilising thread may be woven into a one-dimensional and/or unidirectional ply to hold the metallic wires and reinforcing fibres together. A ply of this type is still one-dimensional provided the metallic wires and/or reinforcing fibres are not interlaced or woven together. For example, the stabilising thread may be woven into the ply in a warp direction, preferably only in a warp direction.

The stabilising thread may, for example, hold together the metallic wires and/or reinforcing fibres in one or more ply(s) (e.g. one or more unidirectional ply(s)). The stabilising thread may, for example, hold together two or more plies. Of the two or more plies held together by the stabilising thread, each ply may independently be unidirectional.

For example, the stabilising thread may form single-layered, biaxial, triaxial or quadriaxial fabric. For example, the stabilising thread may form layers of non-crimp fabric (NCF) or non-crimp woven fabric (NCW). In non-crimp fabric, the fibres and/or wires of each layer can be positioned at any angle relative to each other. In non-crimp woven fabric, the fibres and/or wires of each layer can be positioned at 0° or 90° relative to each other.

The term unidirectional as used herein indicates the reinforcing fibres and wires are parallel or substantially parallel and run in a single direction in a given ply or layer or the majority thereof run in a single direction in a given ply or layer, and that there is no or minimal or reduced out of plane displacement of the fibre and/or wires. However, the term “unidirectional” is well understood in the field of composite materials. There may be a small number of fibres or other material which run in a direction other than the single direction referred to. The main intention of these other fibres or secondary fibres (or other material) may be to hold the primary fibres in place, although the secondary fibres may also afford some structural integrity or properties for the composite material. By “out of plane” is meant the main plane of a given ply. Out of plane displacement may be measured. More particularly, out of plane displacement may be measured in relation to the tensile strength. If the wires are completely aligned then the tensile strength will be at its maximum or ultimate value.

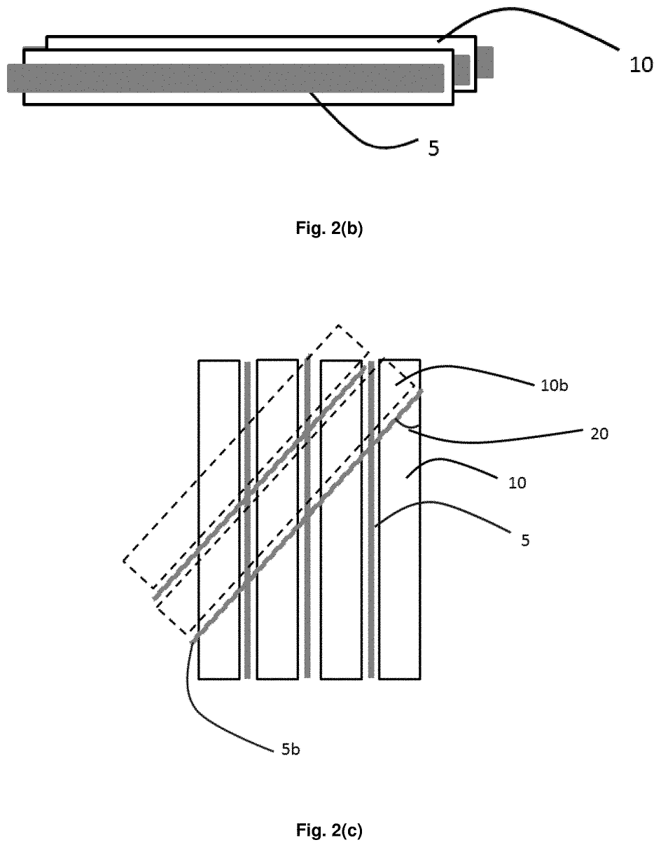

FIG. 2a shows a cross-sectional illustration of an embodiment of a composite material including a 1D preform. In FIG. 2a, the composite material is indicated generally at (1). The composite material includes reinforcing fibres (or tows of reinforcing fibres) (10) and metallic wires (5). The wire(s) (5) are at the lateral edge(s) of the reinforcing fibre(s) (10). In the embodiment shown, each wire may be said to be associated with a particular reinforcing fibre. The number of wires associated with a particular reinforcing fibre may be 1 or 2 or 3 and the number may vary from tow to tow. In a given composite structure, the number of wires associated with any given reinforcing fibre may be 1 or 2 or 3. The reinforcing fibres (10) and wires (5) are embedded in a polymer matrix (15). FIG. 2a is a plan view of a single ply. The reinforcing fibres (10) and metallic wires (5) are shown running in a single (uni) direction. This is further illustrated in FIG. 2b which is a side view of the composite material shown in FIG. 2a. For ease of reference, the reinforcing fibre (10) and metallic wire (5) are shown in the absence of polymer.

FIG. 2c shows a cross sectional illustration of an embodiment of the composite material including two plies. For clarity, the polymer matrix, indicated at (15) in FIG. 2 is not shown. The second ply or layer, positioned underneath the first ply and shown in dotted lines (partly), includes reinforcing fibres (10b) and metallic wires (5b). The reinforcing fibres (10b) and wires (5b) are also embedded in the polymer matrix (15). The angle the second layer or ply makes with respect to the first ply is indicated at (20). The composite material may be made of many plies and the angle (20) may vary from layer to layer or between two adjacent layers (or plies) within a composite material. When there is variance in direction between two adjacent layers, the angle indicated at (20) may range from >0° up to about 179° and be any value in between i.e. any value which is greater than 0° and up to and including about 179° (or less than 180°). The angle indicated at (20) may be 0° when comparing any two adjacent or non-adjacent layers.

In FIGS. 2a, 2b and 2c, the fibres and wires in a given layer (or ply) are not woven with fibres or wires in a different layer (or ply).

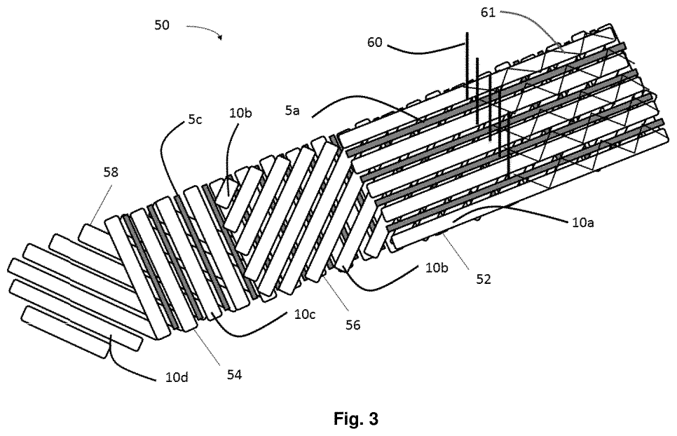

FIG. 3 shows a preform material in the form of a non-crimp fabric possessing four layers and showing an example of a quadriaxial fabric. In FIG. 3, the preform is indicated generally at 50. The preform shown includes four layers or plies indicated at 52, 54, 56 and 58. Two of the four layers in the embodiment shown include essentially the same arrangement of fibres and wires. In each of the layers 52 and 54 the wires are indicated at 5a and 5c respectively and the fibres indicated at 10a and 10c. The layers 52 and 54 are shown staggered in relation to one another and at an angle of 90°. Layers 56 and 58 include tows of fibres (10b, 10d). As a representative layer, reference may be made to layer or ply 52. The arrangement of wires and fibres is essentially that described in connection with FIG. 2a. FIG. 3 shows how the orientation of the unidirectional fibres and wires in a given layer may vary when compared to adjacent layer(s) or non-adjacent layers. In FIG. 3, the metallic wires are shown positioned at the lateral edge of fibre tows. Non-crimp fabric materials or multiaxial fabrics or preform materials more generally can include or may consist of or include single ply uniaxial, two ply biaxial, three ply triaxial or four ply quadriaxial arrangements. Metallic wires may be incorporated in any of the layers positioned at the lateral edge(s) of the fibres. In FIG. 3, wires are shown in two of the layers. Multiple layers or plies of non-crimped fabric may be referred to as blankets which may be stacked and impregnated with resin which may then be cured to form the composite material. The stitching location is illustrated at (60) stitches hold together the layers with a thin yarn or thread (61). This is typically carried out on a machine which is based on a knitting process, such as those made by Liba, Malimo and Mayer. The stitching pattern and tension can be controlled and changed in order to vary the precision with which the fibres are laid down, particularly in maintaining the fibres parallel relative to each other or substantially parallel. These knitting machines include a frame which simultaneously draws in fibres for each axis/layer until the required layers have been assembled and then stitches them together.

### Two-Dimensional Plies

A two-dimensional (2D) ply refers to a ply in which at least some (e.g. all) of the metallic wires and/or reinforcing fibres are interlaced (e.g. woven) together to form a single unitary two-dimensional structure or structure that has a single plane. Thus, in certain embodiments, the composite materials and preforms described herein may include metallic wires and/or reinforcing fibres that are interlaced (e.g. woven) together to form a two-dimensional structure or structure that has a single plane.

The preforms and composite materials described herein may include a single 2D ply. Alternatively, the preforms and composite materials described herein may include two or more 2D plies. In some embodiments, the two or more 2D plies may be connected by one or more metallic wires and/or reinforcing fibres to form a 3D ply as described herein.

The metallic wires and/or reinforcing fibres in the 2D ply may, for example, be woven, braided or knitted. The structure of each ply (e.g. non-interlaced, woven, braided, knitted, 3D) in the composite material and preforms described herein may, for example, be the same or different. In certain embodiments, all or most of the plies in the composite materials and preforms described herein are non-interlaced. In certain embodiments, all or most of the plies in the composite materials and preforms described herein are woven. In certain embodiments, all or most of the plies in the composite materials and preforms described herein are braided. In certain embodiments, all or most of the plies in the composite materials and preforms described herein are knitted. In certain embodiments, all or most of the plies in the composite materials and preforms described herein are 3D.

The term “woven” means that the layer is made by a weaving process involving the interlacing of at least two sets of fibres according to a particular pattern. For example, a woven layer can include or may consist of two sets of fibres (sometimes referred to as warp and weft) that lie perpendicular to each other in the layer plane. For example, a woven layer can include or may consist of three sets of fibres (sometimes referred to as +warp, −warp and filling) or four sets of fibres that are interlaced in the layer plane. For example, the woven layer may be a biaxial or triaxial or quadriaxial woven layer.

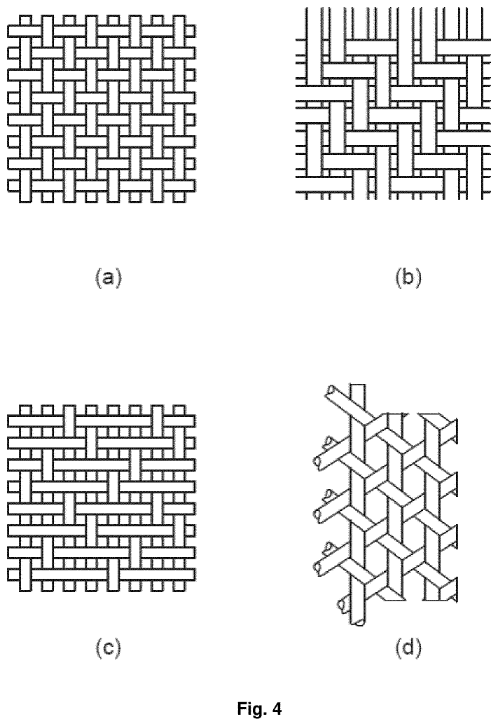

The woven layer may, for example, be made according to any suitable pattern. For example, the woven layer may have a uniform plain pattern in which the fibre in one direction (e.g. warp) passes alternatively over and under each fibre that lies perpendicular to it (e.g. weft). For example, the woven layer may have a twill pattern in which the fibre that lies in one direction (e.g. warp) passes over and under two or more fibres that lie perpendicular to it (e.g. weft). In the twill pattern, the weaving of each fibre in one direction may be started at a different point along the fibres lying perpendicular to it in order to give the woven layer a diagonal pattern. For example, the woven layer may have a satin pattern in which the fibre in one direction (e.g. warp) alternatively pass over and under two or more fibres that lie perpendicular to it (e.g. weft). Woven layers with fewer intersections (e.g. fewer places where fibres are passed over or under) may have a smoother surface and lower crimp and will also have better wettability and drapability. However, woven layers with fewer intersections may also have lower dimensional stability. FIG. 4 shows examples of a plain (FIG. 4(a)), twill (FIG. 4(b)) and satin (FIG. 4(c)) pattern in a 2D woven layer. The woven layer may, for example, be biaxial or triaxial. FIG. 4(d) shows a triaxial woven pattern.

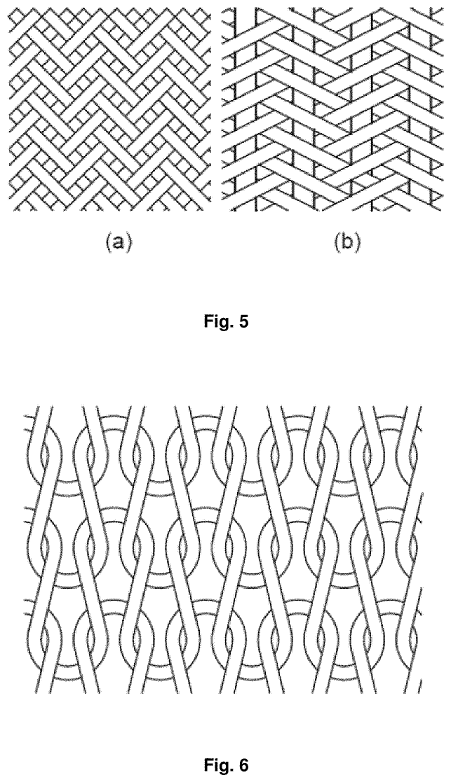

The term “braided” means that the layer is made by a braiding process involving the interlacing of a single set of fibres according to a particular pattern. A braided layer may, for example, can be a layer including or consisting of braiding fibres crossing each other in a diagonal direction to the selvedge. The fibre density may, for example, be even. The layer may, for example, have a closed fabric appearance. The braid pattern may, for example, be a diamond, regular or hercules braid. For example, the braided layer may be a biaxial or triaxial braided layer. FIG. 5 shows examples of a biaxial braided layer (FIG. 5(a)) and a triaxial braided pattern (FIG. 5(b)).

The term “knitted” means that the layer is made by a process involving the interloping of loops of fibre. Adjacent rows or columns of connected loops may also be connected to each other. Thus, a knitted layer may, for example, can include or can consist of two or more consecutive rows of interlocking loops. The knitted layer may, for example, be uniaxial or biaxial. FIG. 6 shows an example of a knitted pattern.

### Three-Dimensional Plies

A three-dimensional (3D) ply refers to a ply in which at least some (e.g. all) of the metallic wires and/or reinforcing fibres are interlaced (e.g. woven) together to form a single unitary three-dimensional structure or structure with more than one plane. Thus, in certain embodiments, the composite materials and preforms described herein may include metallic wires and/or reinforcing fibres that are interlaced (e.g. woven) together to form a three-dimensional structure or structure with more than one plane.

The 3D ply may include multiple wires and/or fibres that are disposed in a three-mutually-perpendicular-planes relationship. The 3D ply may have a third dimension such that the X (longitudinal) and Y (cross) fibres/wires are linked (e.g. intertwined, interlaced or intermeshed) with a Z (vertical) direction wire/fibre. The Z direction fibre/wire can be positioned in any direction outside the X/Y 2D plane.

The preforms and composite materials described herein may include a single 3D ply. Alternatively, the preforms and composite materials described herein may include two or more 3D plies.

The 3D ply may, for example, include two or more 1D and/or 2D plies as described herein that are stacked on top of each other and held together by one or more filaments transversing two or more of the 1D and/or 2D plies. The precise number of plies used may vary depending on the thickness of each ply and the intended application of the composite material or preform.

In certain embodiments, the 3D ply includes 3 or more, or 4 or more, or 5 or more, or 6 or more, or 7 or more, or 8 or more, or 9 or more, or 10 or more, 1D and/or 2D plies that are stacked on top of each other. In certain embodiments, the 3D ply includes up to about 100, or up to about 90, or up to about 80, or up to about 70, or up to about 60, or up to about 50, or up to about 40, or up to about 30, or up to about 20, 1D and/or 2D plies that are stacked on top of each other. In certain embodiments, the 3D ply includes from about 4 to about 30 plies that are stacked on top of each other. In certain embodiments, the 3D ply includes from about 20 to about 30 plies that are stacked on top of each other. By “stacked on top of each other” it is meant that each layer is arranged such that the major planes of each layer are substantially parallel to each other.

When stacked, the direction of the reinforcing fibres and/or metallic wires in each layer relative to the direction of the reinforcing fibres and/or metallic wires in adjacent layers is arranged depending on the performance requirements for the particular fabric or composite material. In certain embodiments, the layers are stacked such that the reinforcing fibres and/or metallic wires in each layer are parallel to the reinforcing fibres and/or metallic wires in one or both adjacent layers. In certain embodiments, the layers are stacked such that the reinforcing fibres and/or metallic wires in each layer are substantially perpendicular to the reinforcing fibres and/or metallic wires in one or both adjacent layers.

The one or more filament(s) transversing two or more of the plies may sometimes be referred to as the z-yarn, warp weaver or binder yarn (particularly for 3D woven plies). The one or more filament(s) extend through the thickness of the 3D-ply connecting the layers. The one or more filament(s) may, for example, extend through the entire thickness of the 3D-ply or may each extend between only certain layers. Each of the layers of the 3D-ply must or should have at least one filament extending therethough in order to hold all or most of the layers of the 3D-ply together.

In certain embodiments, the one or more filament(s) transversing two or more of the plies are each independently reinforcing fibre, metallic wire or a combination thereof. For example, all or most of the one or more filament(s) transversing two or more of the plies are reinforcing fibre, metallic wire or a combination thereof. In certain embodiments, one or more of the one or more filament(s) transversing two or more of the plies is/are reinforcing fibre. In certain embodiments, all or most of the one or more filament(s) transversing two or more of the plies are reinforcing fibre. In certain embodiments, the reinforcing fibre is carbon fibre, for example tows of carbon fibre. In certain embodiments, one or more of the one or more filament(s) transversing two or more of the plies is/are metallic wire. In certain embodiments, all or most of the one or more filament(s) transversing two or more of the plies are metallic wires.

Where the filament(s) are a combination of reinforcing fibre and metallic wire, each reinforcing fibre or metallic wire may be inserted through the plies separately to the other reinforcing fibres and metallic wires. Each filament may, for example, be in the form of tows (bundles of reinforcing fibres or bundles of metallic wires that are not intertwined). Where the filament(s) include a combination of reinforcing fibre and metallic wire, the filament(s) may include combination tows, which each include one or more reinforcing fibres and one or more metallic wire. The combination tows may, for example, include a tow of reinforcing fibres with one or more metallic wires embedded therein.

In certain embodiments, the one or more filament(s) may independently transverse 3 or more, or 4 or more, or 5 or more, or 6 or more, or 7 or more, or 8 or more, or 9 or more, or 10 or more, plies in the 3D-preform. In certain embodiments, the one or more filament(s) may all or most transverse 3 or more, or 4 or more, or 5 or more, or 6 or more, or 7 or more, or 8 or more, or 9 or more, or 10 or more, plies in the 3D-preform. In certain embodiments, the one or more filament(s) may independently transverse up to about 100, or up to about 90, or up to about 80, or up to about 70, or up to about 60, or up to about 50, or up to about 40, or up to about 30, or up to about 20, plies in the 3D-preform. In certain embodiments, the one or more filament(s) may all or most transverse up to about 100, or up to about 90, or up to about 80, or up to about 70, or up to about 60, or up to about 50, or up to about 40, or up to about 30, or up to about 20, plies in the 3D-preform. In certain embodiments, the one or more filament(s) may independently transverse all or most of the plies in the 3D-preform (i.e. 100% of the plies in the 3D-preform from one surface to the other). In certain embodiments, the one or more filament(s) may all transverse all or most of the plies in the 3D-preform (from one surface to the other).

In certain embodiments, each of the one or more filament(s) may transverse the same or a different number of plies in total. Each of the one or more filament(s) may independently transverse the same or different plies within the 3D-preform. For example, each filament may transverse two plies in total but transverse subsequent pairs of plies (e.g. the first filament may transverse the first and second plies, the second filament may transverse the second and third plies etc).

In certain embodiments, each of the one or more filament(s) transversing two or more of the plies of the 3D ply may independently be woven, braided, stitched, tufted or z-pinned. In other words, each of the one or more filament(s) transversing two or more of the plies of the 3D ply are inserted into the structure by weaving, braiding, stitching, tufting or z-pinning. In certain embodiments, all or most of the one or more filament(s) transversing two or more of the plies of the 3D ply are woven. In certain embodiments, all or most of the one or more filament(s) transversing two or more of the plies of the 3D ply are braided. In certain embodiments, all or most of the one or more filament(s) transversing two or more of the plies of the 3D ply are stitched. In certain embodiments, all or most of the one or more filament(s) transversing two or more of the plies of the 3D ply are tufted. In certain embodiments, all or most of the one or more filament(s) transversing two or more of the plies of the 3D ply are z-pinned.

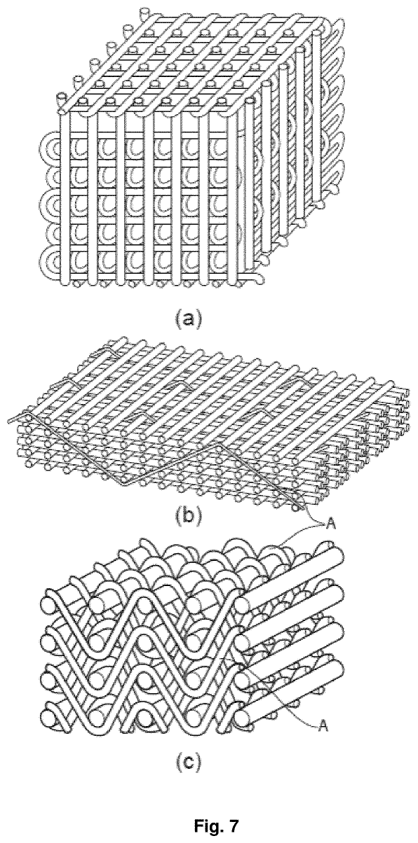

Thus, in certain embodiments, the 3D ply is a 3D woven ply. The 3D woven ply may, for example, be a 3D woven interlock ply or a 3D orthogonal woven ply. The 3D woven interlock ply may be a 3D angle-interlock woven ply or a 3D layer-to-layer interlock woven ply. These plies are semi-interlaced in that the one or more filament(s) transversing two or more plies of the 3D ply are not interlaced within the plies but are only laid-in orthogonally between the plies. In 3D woven preforms, the plies may can include or can consist of non-interlaced fibres/wires. FIG. 7 shows an example of a 3D orthogonal weave pattern (FIG. 7(a)), a 3D angle-interlock weave pattern (FIG. 7(b)) and a 3D layer-to-layer weave pattern (FIG. 7(c)).

In 3D orthogonal woven plies, the fibres are oriented in three orthogonal directions and are interlaced to one another. In 3D angle-interlock woven plies the one or more filament(s) each or all or most extend diagonally in a repeating pattern through all or most of the plies of the preform (i.e. from one surface to the other) and back to hold all or most of the plies together. The one or more filament(s) are thus in a zig-zag pattern through the cross-section of the 3D ply. The filaments transversing the layers of the preform in FIG. 7(b) are in a zig-zag pattern (see, for example, the filament labelled A). In layer-to-layer interlock woven plies the one or more filament(s) each or all or most repeatedly extend from one ply to one or more adjacent plies and back but not through all or most of the plies of the preform. For example, in layer-to-layer interlock woven plies the one or more filament(s) each or all or most extend from one plies to one adjacent plies and back. In layer-to-layer interlock woven plies multiple filaments are required to hold all or most of the plies together. The filaments transversing the layers of the preform in FIG. 7(c) each hold two layers together (see, for example, the filaments labelled A).

Stitching involves inserting the one or more filament(s) through two or more of the plies of the 3D-preform in one direction and then back through the same two or more plies in the opposite direction via a different trajectory/pathway. In certain embodiments, one or more of the stitches are inserted through all or most of the plies of the 3D-preform. In certain embodiments, all or most of the stitches are inserted through all or most of the plies of the 3D-preform. Unlike tufting, each stitch (loop) cannot be pulled back through the material.

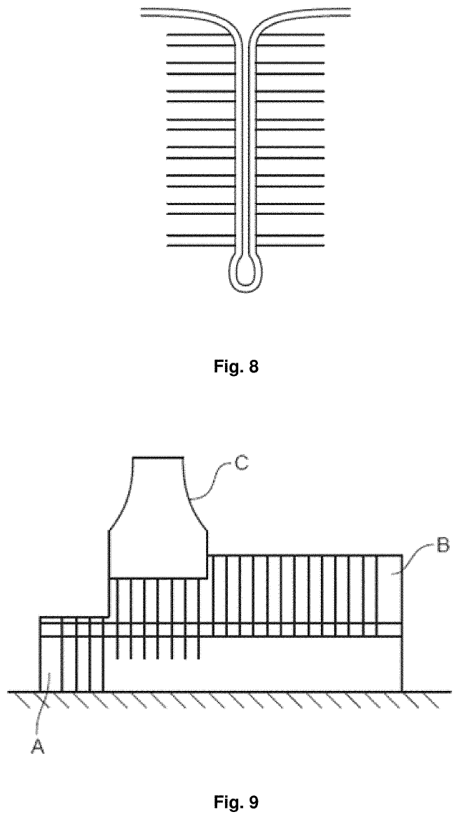

Tufting involves inserting the one or more filament(s) through two or more of the plies of the 3D ply in one direction and then back through the same two or more plies in the opposite direction via the same trajectory. In certain embodiments, one or more of the filament(s) are inserted through all or most of the plies to leave a loop of the filament(s) on the surface of the 3D plies. In certain embodiments, all or most of the one or more of the filament(s) are inserted through all or most of the plies to leave a loop of the filament(s) on the surface of the 3D ply. In certain embodiments, one or more (e.g. all) of the filament(s) are inserted partially through the plies to leave a loop of the filament(s) in the 3D ply. The loop on the surface of the 3D ply is not locked in place and only remains in position due to frictional forces acting on it. In certain embodiments, the one or more tufted filament(s) may each independently be cut to remove the loop. Tufting may be continuous, in which the tufts are made using a continuous thread and each tuft (loop) is linked to the next tuft. Alternatively, tufting may be discontinuous, in which the tufts are made using separate threads and the tufts are not linked. In contrast to stitching, each tuft could be pulled back through the material. FIG. 8 shows an example of tufting.

Z-pinning involves inserting the one or more filament(s) through two or more of the plies of the 3D ply. Each filament extends only once through the two or more plies of the 3D ply. In certain embodiments, each of the one or more filament(s) may independently be inserted through all or most of the plies of the 3D ply. In certain embodiments, all or most of the one or more filament(s) are inserted through all or most of the plies of the 3D ply. In certain embodiments, one or more (e.g. all) of the filament(s) are inserted partially through the plies of the 3D ply. FIG. 9 shows an exemplary method of z-pinning in which A is the uncured stack of layers of reinforced fibres and/or metallic wires, B is the z-pin preform and C is an ultrasonic hammer.

Numerous methods of z-pinning may be used. In certain embodiments, the one or more filament(s) are inserted from a foam bed by pressure and/or acoustic vibration into a 3D ply which may or may not be partially or fully embedded in an uncured polymer matrix.

In certain embodiments, the 3D ply is a fully-interlaced structure in that three or more sets of fibres (e.g. three orthogonal sets of fibres) are interlaced to form a 3D structure. This may, for example, particularly apply to braided and knitted materials.

The fully-interlaced 3D ply may, for example, be a fully-interlaced woven 3D ply, a fully-interlaced braided 3D ply or a fully-interlaced knitted 3D ply.

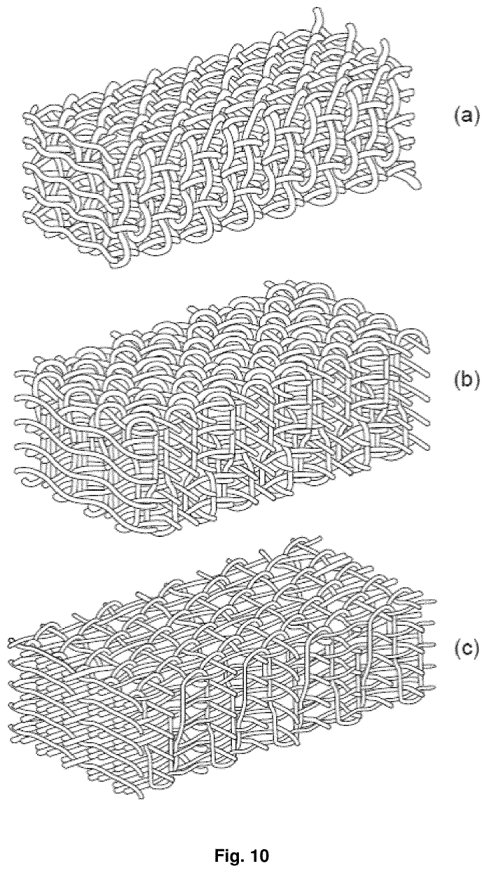

In fully-interlaced woven 3D plies, warp yarns may be interlaced with weft yarns at each layer based on the weave pattern in the in-plane principal directions, whereas z-yarns may be interlaced with warp yarns at each layer based on weave pattern in the out-of-plane principal directions. The fully-interlaced woven 3D ply may, for example, have a fully plain, fully twill or fully satin pattern. The fully-interlaced woven 3D-preform may be a circular fully-interlaced woven 3D ply. In order to form a circular fully-interlaced woven 3D ply, circumferential yarns may be interlaced with axial yarns at each circular layer based on the weave pattern in the circumferential direction, whereas radial yarns may be interlaced with axial yarns at each layer based on the weave pattern in the radial direction. The circular fully-interlaced woven 3D ply may have a fully plain, fully twill or fully satin pattern. The fully-interlaced woven 3D ply may be a multiaxis woven preform. The multiaxis woven fabric may, for example, can include or can consist of 4 or 5 sets of fibres. FIG. 10 shows an example of (a) fully-interlaced plain woven preform, (b) fully-interlaced twill woven preform and (c) fully-interlaced satin woven preform.

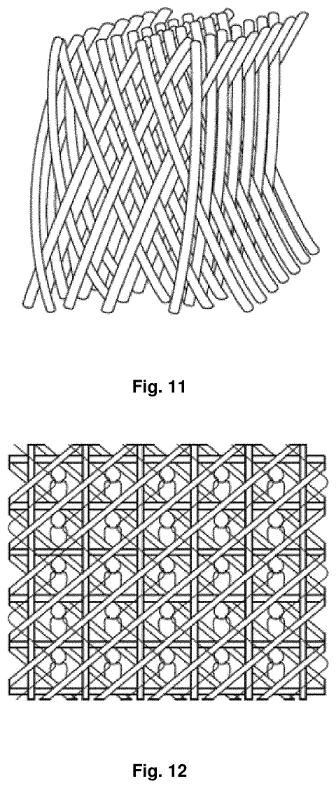

A fully-interlaced braided 3D ply may, for example, be a multiaxis braided preform. FIG. 11 shows an example of a fully-interlaced braided perform. A fully-interlaced knitted 3D-preform may, for example, be a multiaxis knitted preform. FIG. 12 shows an example of a fully-interlaced knitted preform.

The 3D ply may, for example, have any suitable thickness depending on the intended use of the ply. In certain embodiments, the 3D ply has a thickness ranging from about 1 mm to about 800 mm. For example, the 3D ply may have a thickness ranging from about 1 mm to about 700 mm or from about 1 mm to about 600 mm or from about 1 mm to about 500 mm or from about 1 mm to about 400 mm or from about 1 mm to about 300 mm or from about 1 mm to about 200 mm or from about 1 mm to about 100 mm. For example, the 3D ply may have a thickness ranging from about 1 mm to about 90 mm or from about 1 mm to about 80 mm or from about 1 mm to about 70 mm or from about 1 mm to about 60 mm or from about 5 mm to about 50 mm or from about 10 mm to about 45 mm or from about 20 mm to about 40 mm.

### Polymer Matrix

The composite materials described herein include a cured polymer matrix in which the metallic wires and reinforcing fibres are embedded. The preforms described herein are used to make the composite materials and may or may not include a polymer resin that has not been cured. A preform including a polymer resin that has not been cured may be referred to as a prepreg material.

The matrix material in the composite material, (and resin in a prepreg material) may be of any of the usual types employed in fibre reinforced polymer (FRP) composites. For example, the matrix material (or precursor or prepolymer thereof) may be a thermosetting resin or a thermoplastic resin.

In certain embodiments, the polymer matrix is (or formed from) an epoxy (resin), an acrylic (resin), a polyester, a polyvinyl ester, a polyurethane, a phenolic (resin), an amino (resin), a furan (resin), a bismaleimide (resin), a cyanate ester (resin), a polyimide (resin), a phthalonitrile (resin) or a polysilazane (resin).

In certain embodiments, the polymer matrix is (or formed from) an epoxy (resin). The final cured version of the epoxy resin may be referred to as a polyepoxide. In embodiments of the presently disclosed subject matter, the polymer can include or may consist of or consist essentially of or include any one of the listed polymers. The polymer matrix can include or may consist of or consist essentially of or include any combination of the listed polymers.

The polymer resin may be applied to a preform as described herein and cured to make a composite material as described herein. For example, the preform may be infused with resin. Infusion may be achieved using resin transfer moulding (RTM) or any of the other known infusion techniques. The resin may be applied using moulding methods such as injection moulding. The resin may be applied using moulding methods such as injection moulding, or infusion processes such as resin transfer moulding. A preform material combined with a polymer material that is not cured may be referred to as a prepreg material.

The polymer resin may be cured using standard techniques for curing the polymers. For example, the resin may be cured using any one or combination of heat and UV radiation for appropriate time until curing is complete. The resin may be cured for an appropriate time until curing is complete. Curing may take place at room temperature.

Curing may include the use of an autoclave curing method or an out of autoclave curing method. For example, curing may include the use of autoclave ramp and curing temperatures and conditions. These temperatures and conditions may be consistent with the manufacturing method defined by the manufacturer of a resin system. Typically, a resin manufacturer will provide a datasheet which includes details of a suitable cure cycle. By way of example, the curing conditions for a commercially available prepreg material are provided below and relate to the use of an epoxy resin and unidirectional or woven fibres of carbon fibre or glass fibre and is cured in the presence of an amine curing agent. These conditions are suitable for use in some embodiments.

### Example Curing Conditions:

1. Apply full vacuum (1 bar).
2. Apply 7 bar gauge autoclave pressure.
3. Reduce the vacuum to a safety value of 0.2 bar when the autoclave pressure reaches approximately 1 bar gauge.
4. Heat at 1-3° C./min (2-8° F./min) to 110° C.±5° C. (230° F.±9° F.)
5. Hold at 110° C.±5° C. (230° F.±9° F.) for 60 minutes±5 minutes.
6. Heat at 1-3° C./min (2-8° F./min) to 180° C.±5° C. (356° F.±9° F.)
7. Hold at 180° C.±5° C. (356° F.±9° F.) for 120 minutes±5 minutes.
8. Cool at 2-5° C. (4-9° F.) per minute
9. Vent autoclave pressure when the component reaches 60° C. (140° F.) or below.

In certain embodiments, the processing temperatures of the composite material (e.g. up to about 180° C. or up to about 400° C.) do not change the stress-strain curve of the metallic wire at 25° C. In other words, the stress-strain curve of the metallic wire at 25° C. before incorporation into a composite material is the same as the stress-strain curve of the metallic wire at 25° C. after incorporation into a composite material. Processing of the metallic wires at high temperatures does not permanently change the stress-strain curve of the metallic wires. In certain embodiments, the processing temperatures of the composite material do not change the stress-strain curve of the metallic wire at 25° C. provided the processing temperatures do not exceed the temperatures that were originally used to make the metallic wires.

Typically, the pre-cured materials may be exposed to heat and/or light of an appropriate wavelength at the same time that they are laid onto a substrate or shortly thereafter. Pressure may also be applied during curing. Pressure may be applied using a vacuum such as via the use of a vacuum bag. The polymer resin may include a catalyst and/or curing agent in order to assist with curing. For example, the curing agent may be, or include, an amine compound, for example an aromatic or aliphatic amine compound. The pre-cured materials may be used to form the composite material using a hand lay-up technique.

A prepreg material as described herein may, for example, be cut to suitable dimensions to form a tape. The tape may possess a width of equal to or less than about 8 cm, for example less than about 6.5 cm, or less than about 5 cm or less than about 3 cm. The tape may be at least about 3 mm wide. The tape may possess or can include or can consist of a single layer or ply of prepreg material. Typically, the tape may be formed or prepared on a substrate such as paper or polymer which is provided as backing. The substrate, e.g. paper or polymer, is removed prior to the tape being deposited on a surface or a mould.

### Metallic Wires

The metallic wires used in the composite materials and preforms described herein may have a high energy absorption capability. The metallic wires may, for example, be referred to as metallic fibres. Where the specification generally refers to the fibres in each layer, this may include reinforcing fibres and metallic wires.

In certain embodiments the metallic wires are shape memory alloy (SMA) wires. In certain embodiments the metallic wires are non-SMA wires. The non-SMA wires may, for example, be steel wires.

The metallic wires may be of any type which offers the stress-strain characteristics defined herein. More particularly, such metallic wires may be formulated such that the capacity of the wires to absorb strain energy at the operating temperature of range of operating temperature of the composite material is maximised. The metallic wires may, for example, have a martensite or austenite crystal structure.

An SMA wire may be of any type which offers the stress-strain characteristics of a shape memory alloy system. More particularly, such alloys may be formulated such that the capacity of the wires to absorb strain energy at the operating temperature or range of operating temperature of the respective material is maximised. The alloys may be formulated such that the capacity of the wires to absorb strain energy at the operating temperature or range of the operating temperature of the respective material may be due to either of the known hysteretic responses of martensitic twinning (shape memory effect) or martensitic transformation (superelasticity) or a combination of the two.

Advantageously, the alloy may be mainly or solely in the martensitic twinning form. This may be when in operation and/or included in a composite or an article disclosed herein.

The currently preferred SMA alloy is of the Ti—Ni type (nitinol) although other candidates may include ternary alloys Ti—Ni—Cu, Ti—Ni—Nb or Ti—Ni—Hf, copper-based SMAs such as Cu—Zn—Al, Cu—Al—Ni, Cu—Al—Zn—Mn, Cu—Al—Ni—Mn or Cu—Al—Mn—Ni or iron-based SMAs such as Fe—Mn—Si, Fe—Cr—Ni—Mn—Si—Co, Fe—Ni—Mn, Fe—Ni—C or Fe—Ni—Co—Ti. In certain embodiments, all or most SMA wires in the composite material or preform are the same alloy.

The alloy may be suitably heat treated to obtain the desired stress-strain curve.

The metallic wires may be of a composition and in a proportion to substantially enhance the impact resistance of a composite material at a predetermined operating temperature or range thereof. The volume fraction of the metallic wires in the composite material may typically be in the range about 2-40 vol % or about 2-25 vol %, or about 12 vol % to about 40 vol %, or more particularly about 3-12 vol %.

The metallic wires may be arranged to lie at the lateral edge of a reinforcing fibre tow. The wires may be arranged so that they lie in the same plane as the reinforcing fibres, thus not contributing to any increase in, (or minimising), ply thickness in the main plane of any given ply.

Each metallic wire may, for example, have a diameter ranging from about 50 μm to about 1000 μm. For example, each metallic wire may have a diameter ranging from about 100 μm to about 900 μm or from about 100 μm to about 800 μm or from about 100 μm to about 700 μm or from about 100 μm to about 600 μm or from about 100 μm to about 500 μm or from about 100 μm to about 400 μm or from about 100 μm to about 300 μm. Each metallic wire may, for example, have a diameter ranging from about 200 μm to about 300 μm. For example, each metallic wire may have a diameter ranging from about 210 μm to about 290 μm or from about 220 μm to about 280 μm or from about 230 μm to about 270 μm or from about 240 μm to about 260 μm. Each metallic wire may, for example, have a diameter ranging from about 100 μm to about 300 μm. The metallic wire or wires may be of a circular cross-section.

In a variant of the presently disclosed subject matter, the metallic wires are not of circular cross-section but have an elliptical, oval, or otherwise “flattened” cross-section which is substantially longer in a first dimension than in a second dimension perpendicular to the first. The non-circular cross-section metallic wires may, for example, be woven into layers of the 3D-preform with the longer dimension generally parallel to the plane of the layer. Metallic wires with a flattened cross-section may particularly be used such that the metallic wires have the same or smaller thickness as the reinforcing fibres without reducing the amount of metallic that is used in each wire. It may, for example, be particularly advantageous to use flattened metallic wires to obtain thin layers.

Where the metallic wire has an elliptical, oval or otherwise flattened cross-section, the metallic wire may have a major cross-sectional diameter ranging from about 200 μm to about 400 μm or from about 260 μm to about 340 μm or from about 270 μm to about 330 μm or from about 280 μm to about 320 μm. The metallic wire may, for example, have a minor cross-sectional diameter ranging from about 100 μm to about 250 μm or from about 260 μm to about 340 μm or from about 270 μm to about 330 μm or from about 280 μm to about 320 μm. Compared to circular wires of the same cross-sectional area this may achieve a reduction in the overall thickness of the preform material and associated prepreg material and composite material.

Similarly, for a given thickness, a single flat wire may have the same volume of metal as a combination of two or more circular wires, but should be tougher due to the greater homogeneous volume. There may also be cost advantages as, per unit volume of metal material, the single wire should be cheaper to produce.

In certain embodiments, the metallic wire is in the form of a sheet, wherein the sheet is embedded in the polymer matrix of the composite material. The composite material may, for example, include one or more, for example two or more, three or more, four or more, five or more, six or more, seven or more, eight or more, nine or more or ten or more sheets of metallic wire stacked on top of each other (the planes of the sheet being parallel to each other). The sheet may, for example, have a surface area that is at least about 90% of the surface area of the composite material. For example, the sheet may have a surface area that is at least about 91% or at least about 92% or at least about 93% or at least about 94% or at least about 95% or at least about 96% or at least about 97% or at least about 98% or at least about 99% of the surface area of the composite material.

The metallic wires function in a purely passive sense, in that they are not intended to change shape in response to temperature change in use of the respective structure. Further, means for deliberately applying an electrical voltage to the wires or otherwise initiating their thermal transformation may not be provided, in contrast to known active structures which employ heated SMA elements to impart motion or apply a force.

The metallic wires will also not normally be prestrained within the preform material. However either of those measures may be employed. For example, it might be possible to temporarily repair a damaged structure or avoid catastrophic failure by reversing its deformation by heating. Other functionality may also be exhibited in the passive role; for example the metallic wires may impart enhanced damping or other energy absorbing properties to the structure or provide lightning strike protection or other electrical bonding.

### Reinforcing Fibre

The reinforcing fibres may be any of the usual types employed in fibre reinforced polymer (FRP) composites. The reinforcing fibres may be non-SMA and/or non-metallic reinforcing fibres. In certain embodiments, the reinforcing fibres have a tensile modulus in excess of 50 GPa. In certain embodiments, the reinforcing fibres have a tensile modulus equal to or greater than about 60 GPa or equal to or greater than about 80 GPa or equal to or greater than about 100 GPa or equal to or greater than about 120 GPa or equal to or greater than about 140 GPa or equal to or greater than about 150 GPa or equal to or greater than about 160 GPa or equal to or greater than about 180 GPa. In certain embodiments, the reinforcing fibres have a tensile modulus in excess of 200 GPa. Tensile modulus may, for example, be measured by ASTM D3379.

In certain embodiments, the reinforcing fibres may be selected from carbon fibres (CF), (including graphite), glass fibres, aramid fibres (e.g. Kevlar®), (high modulus) polyethylene fibres, boron fibres or a combination thereof. In certain embodiments, the reinforcing fibres are one of carbon fibres (including graphite), glass fibres, aramid fibres (e.g. Kevlar®), high modulus polyethylene fibres and boron fibres. In certain embodiments, the reinforcing fibres are carbon fibres. The reinforcing fibres may be selected from one or any combination of the listed fibres.

In certain embodiments, carbon fibres have a tensile modulus equal to or greater than about 200 GPa, for example ranging from about 200 GPa to about 1000 GPa or from about 200 GPa to about 800 GPa or from about 200 GPa to about 600 GPa or from about 200 GPa to about 400 GPa or from about 200 GPa to about 300 GPa. In certain embodiments, glass fibres and/or aramid fibres (e.g. Kevlar®) and/or ultra high molecular weight polyethylene fibres have a tensile modulus equal to or greater than about 50 GPa, for example ranging from about 50 GPa to about 200 GPa or from about 50 GPa to about 150 GPa or from about 50 GPa to about 100 GPa.

The reinforcing fibres may, for example, be carbon fibres having a diameter ranging from about 5 μm to about 10 μm, for example from about 6 μm to about 9 μm, for example from about 7 μm to about 8 μm.

The reinforcing fibres may, for example, be present in tows (untwisted bundles of fibres). The tows may, for example, comprise from about 1000 (1 k) to about 50,000 individual fibres (e.g. 48 k). For example, the tows may include from about 1000 to about 40,000 or from about 1000 to about 30,000 or from about 1000 to about 20,000 or from about 1000 to about 10,000 or from about 2000 to about 9000 or from about 3000 to about 8000 or from about 4000 to about 7000 individual fibres. The dimensions and number of fibres mentioned herein is applicable to any of the fibres used in connection with the present disclosure and is not limited to carbon.

### Use and Articles of Manufacture

There is also provided herein the use of the composite materials and preforms described herein to make an article of manufacture. There is also provided herein articles of manufacture made from or including the composite materials and preforms described herein.

In certain embodiments, the article of manufacture is a part for a vehicle. In certain embodiments, the article of manufacture is a part for an aircraft, a marine craft or an automobile.

In certain embodiments, the article of manufacture is a forward-facing part of a vehicle. The article may be selected from a part of a vehicle, such as an aircraft, including a wing or a part of a wing, for example a leading edge of a wing or a wing panel. The article may form part of an aero engine, for example be included in a nacelle. In certain embodiments, the article of manufacture is a leading edge, nose cone or nacelle. In certain embodiments, the article of manufacture is a leading edge of an aircraft wing.

In certain embodiments, the article of manufacture is a protective cover. In certain embodiments, the article of manufacture is a protective cover for a battery, a protective cover for a fuel tank or a protective cover for a braking system.

### Methods of Manufacture

There is further provided herein methods of making the preforms, prepreg materials and composite materials described herein. Conventional FRP composite fabrication methods may be employed.

The methods may, for example, include making a preform embedded in an uncured polymer matrix and curing the polymer matrix. For example, the method may include stacking plies of preforms embedded in an uncured polymer matrix and curing the polymer matrix.

The methods may, for example, include making a preform, applying a polymer matrix to the preform and curing the polymer matrix with the preform embedded therein.

### Methods of Making the Preform

There is further provided herein methods of making a preform according to any aspect or embodiment described herein. The method includes arranging metallic wires and/or reinforcing fibres into a preform structure.

The metallic wires and reinforcing fibres may be arranged by any suitable method to get the desired arrangement. For example, the metallic wires and optional reinforcing fibres may be arranged into a 1D, 2D or 3D structures as described herein.

The 1D preforms described herein may be made by drawing fibres, for example from a spool or spools and aligning the fibres so that all or substantially all of the fibre tows run parallel or substantially parallel to one another. Metallic wires may be positioned between the tows of reinforcing fibres and along the lateral edge of the tows of reinforcing fibres. Typically, one, two or three metallic wires may be positioned next to any given fibre tow.

Dry preforms (preforms that do not include any polymer resin) including at least one or greater than one ply may be made using a non-crimped woven method or a non-crimped fabric manufacturing method. The terminology “non-crimped woven” is intended to indicate that though an element of weaving is introduced into the structure, the reinforcing fibres and metallic wires remain unwoven in that they retain their unidirectional nature, i.e. there is no, or minimal, change in the primary direction of the fibres and wires in an out of ply plane direction. The term unidirectional as used herein indicates the reinforcing fibres and wires are parallel or substantially parallel and run in a single direction (the fibres and wires may be referred to herein as primary fibres and wires), in a given ply or layer or the majority thereof run in a single direction in a given ply or layer, and that there is no (or minimal) out of plane displacement of the fibre and/or wires. There may be a small number of threads or other material which may run in a direction other than the single direction, the main intention of these other threads or secondary fibres may be to hold the primary fibres in place. By “out of plane” is meant the main plane of a given ply. Out of plane displacement may be measured and, more specifically, may be measured in relation to the tensile strength. If the wires are completely aligned (and there is no, or minimal, crimping), then the tensile strength will be at its maximum or ultimate value.

The non-crimped woven or fabric structures may be made as follows. Layers or plies of non-crimp woven which may be dry (or pre-impregnated with resin if the intention is to form a prepreg material) may be stacked to form a multi-ply structure. Each ply relative to the next ply immediately adjacent may be orientated to provide the desired in-plane structural properties. Once the required number of layers or plies is stacked, the material may be cured to form a composite material for those structures which are pre-impregnated or for those structures which are dry, impregnated with a resin system, for example using injection moulding, and then cured to form a composite material.

2D preforms may, for example, be made by one or more of weaving, braiding and knitting using methods known to those of ordinary skill in the art. The 2D-preform may, for example, be made using the existing apparatus for weaving, braiding and knitting. The existing apparatus may, for example, be adapted depending on the particular desired 2D-preform to be made.

3D preforms may also be made by one or more of weaving, braiding, knitting, stitching, tufting and z-pinning. The 3D-preform may, for example, be made using existing apparatus for weaving, braiding, knitting, stitching, tufting and z-pinning. The existing apparatus may, for example, be adapted depending on the particular desired 3D-preform to be made.

In certain embodiments, a 3D-preform may be made by stacking layers of 1D and/or 2D arrangements of metallic wires and/or reinforcing fibres and inserting one or more filament(s) transversing two or more of the layers to make a 3D-preform. Each layer may or may not be pre-impregnated with polymer resin. The one or more filament(s) transversing two or more layers may be inserted before or after polymer matrix is applied to the layers. The polymer resin is cured after the one or more filament(s) transversing two or more of the layers has/have been inserted. In certain embodiments, the one or more filament(s) transversing two or more of the layers are inserted by stitching, tufting or z-pinning. In certain embodiments, the one or more filament(s) transversing two or more of the layers are inserted by z-pinning. In certain embodiments, the method includes making a preform by stacking layers of reinforcing fibres, metallic wires or a combination thereof, inserting one or more filament(s) transversing two or more of the layers to make a 3D-preform, applying a polymer matrix, and curing the polymer matrix. In certain embodiments, the one or more filament(s) transversing two or more of the layers are inserted by stitching, tufting or z-pinning. In certain embodiments, the one or more filament(s) transversing two or more of the layers are inserted by z-pinning.

### Methods of Making Prepreg Materials and Composite Materials

The prepreg and composite materials described herein may include making a preform material as described herein and applying a polymer resin to the preform material. The polymer resin is cured to make a composite material.

Alternatively, the metallic wires and/or reinforcing fibres that form the preform material may be coated with a polymer resin before they are arranged into a preform structure. Additional polymer resin may or may not be then applied to the preform structure. The polymer resin is cured to make a composite material.

The resin may be applied using a solvent based process or a hot melt process. In the hot melt process, there are typically two stages. The first stage of the process may include coating a thin film of the heated resin on to a substrate, e.g. a paper or polymer substrate. The substrate may be referred to as a backing. The fibres, metallic wires and resin (which may be present on the substrate) may be combined in a prepreg machine. On application of heat and pressure, the resin is impregnated into the fibre resulting in the formation of the prepreg which may be subsequently wound on a core, effectively for storage prior to being used for forming or coating an article. In forming or coating an article, the substrate or backing is removed and the prepreg positioned on the article in any desired number of layers and cured to form the composite material.

Tape may be considered as falling under the more general term of prepreg material in so far as tape is prepreg material possessing a certain range of dimensions, typically in connection with thickness and width. Tape is typically provided on a substrate or backing such as a polymer backing or a paper backing. The backing may be referred to herein as a substrate. The backing is removed prior to the tape being applied to an article and cured during or following application. Tape in accordance with some embodiments is generally taken to mean a prepreg material possessing a single ply and width in the range of about 3 mm to less than or equal to about 8 cm.

The polymer resin may, for example, be cured by any suitable method, for example by any method described herein.

### Methods of Making Articles of Manufacture

Any suitable method may be used to make the articles of manufacture described herein.

The composite material and/or prepreg material described herein are particularly suitable for use in tape or fibre laying processes. For example, the materials in accordance with the disclosure are particularly useful in automatic tape laying (ATL) and automatic fibre placement (AFP) techniques.

Automated tape laying (ATL) and automated tape placement (ATP) are processes that use computer guided robotics to lay one or several layers of prepreg material in the form of a tape onto a mold or substrate to create a structure or article or part thereof. The prepreg material is laid and then cured to form a polymer composite material.

In a typical ATP or ATL technique, prepreg plies of material containing a mixture (or preform) of reinforcing fibres and metallic wires may be produced using a fabrication line. Metallic wire(s) may be fed from a roll or spool and aligned and combined into a single layer, ply or lamina, along with reinforcing fibres which may be supplied from a separate spool or roll. Alignment of the metallic wires and reinforcing fibres may be such that they form alternating rows of metallic wires and reinforcing fibres that are then combined with a flexible film of resin supplied from a further spool or roll. The single layer of fibres and wires may be pressed onto a resin film, for example, by further rollers and subsequently passed over a heating element which heats the resin film to its free-flowing temperature. Consolidation rollers may be used to impregnate the melted resin film onto the arrangement of fibres and wires in order to form a prepreg tape that may be taken up on to a spool. The prepreg tape may then be applied to an article and cured.

The composite materials in accordance with the disclosure may be made using an automated fibre placement (AFP) technique.

An automated fibre head placement device including an AFP head component, which itself includes a number of channels into which may be fed a number of fibres and metallic wires. The fibres are pre-coated or pre-impregnated in polymer resin and along with the wires are fed through the head which aligns the fibres and wires so that they exit in a unidirectional arrangement. The material exiting the section of the head is tacky or essentially in the form of a prepreg material and is placed on a mould or mould tool, for example using a roller. The AFP head aligns the metallic wires and fibres so that the metallic wires are positioned on or at the lateral edge of the fibre (e.g. carbon) tow. The gap between the tows and the wires may be as low as possible. At the time of laying or placement of the prepreg material, or shortly thereafter, the prepreg material is cured, e.g. by heat and/or UV. Alternatively, the preform can be infused using a resin infusion method such as injection moulding. The AFP apparatus may further include a cutting blade suitable for cutting metallic wires and mounted spools for the metallic wire which regulate the rate and amount of wire which is fed in to the AFP head component.

The foregoing broadly describes certain embodiments of some embodiments without limitation. Variations and modifications as will be readily apparent to those of ordinary skill in the art are intended to be within the scope of some embodiments as defined in and by the appended claims.

### EXAMPLES

### Example 1

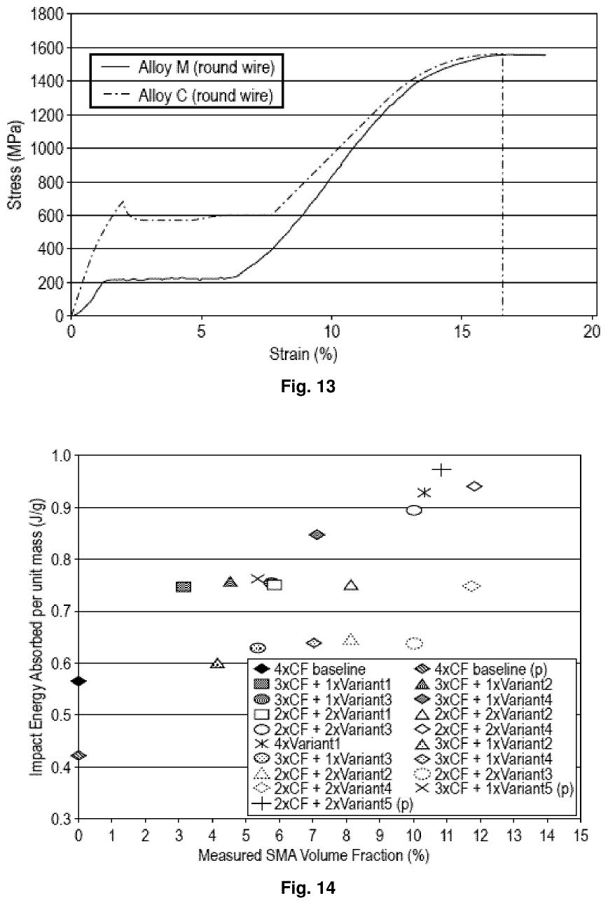

A load (N) versus extension (mm) test was performed on two different Ni—Ti SMA wires. The SMA wire of alloy C is in austentic form whereas the SMA wire of alloy M is in martensitic form. The results are shown in FIG. 13.

The data was obtained from single wire tests using a screw-driven Instron tensile test machine with a 1 kN load cell. The wire was clamped at either end using a soft grip to ensure failure at the centre of the sample and pulled at a constant cross-head speed of 5 mm/min.

The area under the curve for a single wire of alloy type C was slightly higher than alloy type M. It was therefore assumed that, for the same volume of wire embedded within a composite, composites containing alloy C would absorb slightly more energy or at least equal amounts of energy before failure than composites containing alloy M. However, when these wires were embedded in a range of woven composites (e.g. 1 wire between each warp and weft carbon tow or 2 wires between each warp and weft carbon tows), it was found that the alloy C wires were less beneficial in the composite in terms of penetration resistance, the penetration resistance being a measure of the energy the composite panel could absorb prior to penetration. The values were measured using an instrumented drop-weight impact tested with a fully supporting 100 mm diameter ring and a 16 mm diameter tup.

In this case, both alloys M and C met the (b) and (c) criteria specified herein. However, alloy C did not meet criteria (a).

FIG. 14 shows the measured penetration resistance for several different composite panels where the SMA reinforced plies have been placed in different locations through the panel. The graph shows the total volume of wire in each panel with each panel made up of plies of SMA reinforced composite with either 1, 2 or 3 wires between each warp tow and 1, 2 or 3 wires between each weft tow. The number of plies with SMA wires was varied between 1 or 2 plies in an 4 ply lay-up to vary the volume of SMA wire. FIG. 14 shows that the panels containing alloy M wires consistently deliver a higher penetration resistance that those with alloy C wires.

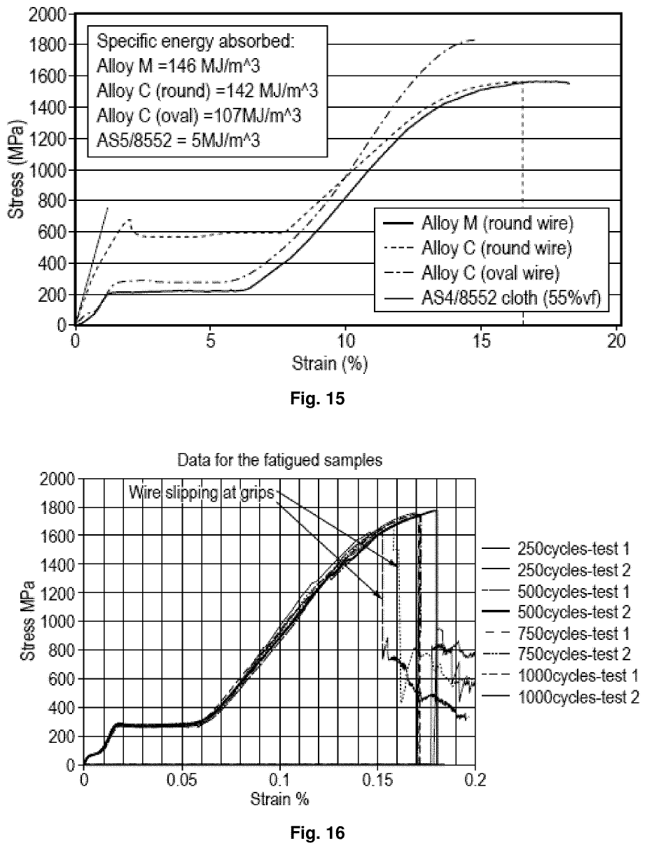

FIG. 15 shows the difference in the stress-strain curve obtained for a woven composite (without SMA wires) and the SMA wires themselves. FIG. 15 shows that the initial modulus for the alloy C wire is similar to that of the baseline composite material. The stress-strain curve of an oval alloy C wire has an initial modulus lower than that of the round alloy C wire. This wire also provided superior penetration resistance in a woven composite than the round alloy C wires.

The specific energy absorbed by the composite and wires shown in FIG. 15 was also calculated. The results are shown in Table 1 below.

TABLE 1

| Material | Specific Energy Absorbed (MJ/m³) |
|---|---|
| Alloy M (round wire) | 146 |
| Alloy C (round wire) | 142 |
| Alloy C (oval wire) | 107 |
| AS5/8552 woven composite | 5 |

### Example 2

An SMA wire of alloy M was heat-treated to show that the stress-strain curve at room temperature was unaffected by the processing conditions of a composite.

SMA wires were also cyclically heat-treated to show that, by heating the wire through the austenite transformation temperatures, the room temperature wire properties were not affected. Wires were heat-treated between room temperature and 100° C. for up to 1000 cycles.

FIG. 16 shows the stress-strain curve of SMA wires of alloy M after various thermal cycles and heat-treatments.

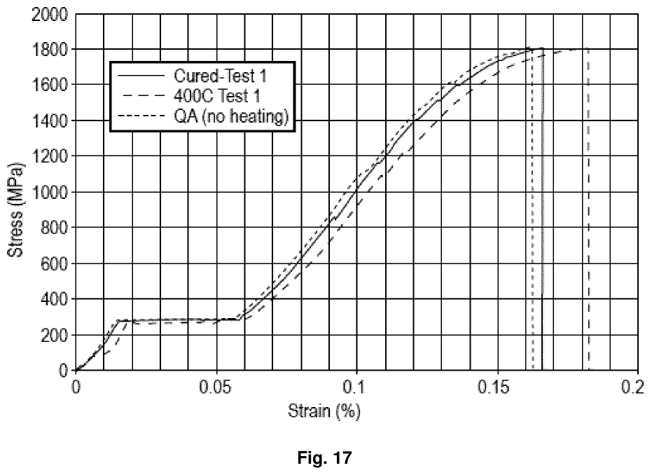

FIG. 17 shows the stress-strain curve of SMA wires of alloy M after exposure to a typical epoxy cure cycle (as described above) and after heat treatment to 400° C. and holding for 2 hrs. This shows that the stress-strain curve at room temperature does not change compared to the wire that did not undergo heat treatment.

1. A composite material comprising a polymer matrix with reinforcing fibres and metallic wires embedded therein, wherein the metallic wires have a stress-strain curve such that:
a) the initial modulus of the metallic wire is less than the initial modulus of a baseline composite material comprising the polymer matrix with the reinforcing fibres embedded therein;
b) the strain at which the stress-strain curve of the metallic wire starts to plateau is greater than the maximum strain of the baseline composite material;
c) the total area under the stress-strain curve of the metallic wire is at least ten times the total area under the stress-strain curve of the baseline composite material; and
wherein the metallic wires are in a passive state.

2. The composite material of claim 1, wherein the initial modulus of the metallic wires is at least about 20% less than the initial modulus of the baseline composite material.

3. The composite material of claim 1, wherein the metallic wires has an initial modulus equal to or greater than about 20 GPa.

4. The composite material of claim 1, wherein the metallic wires has an initial modulus equal to or less than about 35 GPa.

5. The composite material of claim 1, wherein the strain at which the stress-strain curve of the metallic wires starts to plateau is equal to or greater than about 0.5%.

6. The composite material of claim 1, wherein the plateau of the stress-strain curve of the metallic wires ends at a strain equal to or greater than about 4%.

7. The composite material of claim 1, wherein the plateau of the stress-strain curve of the metallic wires occurs at a stress that is less than the maximum stress of the baseline composite material.

8. The composite material of claim 1, wherein the plateau of the stress-strain curve of the metallic wires occurs at a stress equal to or greater than about 100 MPa.

9. The composite material of claim 1, wherein the plateau of the stress-strain curve of the metallic wires occurs at a stress equal to or less than about 350 MPa.

10. The composite material of claim 1, wherein the total area under the stress-strain curve of the metallic wires is at least twelve times, for example at least fifteen times, the total area under the stress-strain curve of the baseline composite material.

11. The composite material of claim 1, wherein the total energy absorbed by the metallic wires is equal to or greater than about 50 MJ/m³.

12. The composite material of claim 1, wherein the maximum strain of the metallic wires is equal to or greater than about 14%.

13. The composite material of claim 1, wherein the maximum stress of the stress-strain curve of the metallic wires is equal to or greater than about 1200 MPa.

14. The composite material of claim 1, wherein the metallic wires are shape memory alloy (SMA) wires.

15. The composite material of claim 14, wherein each SMA wire is independently selected from the group consisting of Ti—Ni, Ti—Ni—Cu, Ti—Ni—Nb, Ti—Ni—Hf, Cu—Zn—Al, Cu—Al—Ni, Cu—Al—Zn—Mn, Cu—Al—Ni—Mn, Cu—Al—Mn—Ni, Fe—Mn—Si, Fe—Cr—Ni—Mn—Si—Co, Fe—Ni—Mn, Fe—Ni—C and Fe—Ni—Co—Ti alloys.

16. The composite material of claim 1, wherein the volume fraction of the metallic wires in the composite material ranges from about 2% to about 25%.

17. The composite material of claim 1, wherein the reinforcing fibres each independently have a tensile modulus in excess of 50 GPa, for example in excess of 200 GPa.

18. The composite material of claim 1, wherein the reinforcing fibres are each independently selected from carbon fibres, glass fibres, aramid fibres (e.g. Kevlar®), polyethylene fibres and boron fibres.

19. The composite material of claim 1, wherein the polymer matrix is formed from an epoxy resin, an acrylic resin, a polyester, a polyvinyl ester, a polyurethane, a phenolic resin, an amino resin or a furan resin.

20. A method for selecting a metallic wire to improve the impact performance and/or penetration resistance of a composite material comprising a polymer matrix with reinforcing fibres embedded therein, the method comprising determining the stress-strain curve of the composite material and selecting a metallic wire having a stress-strain curve such that:
a) the initial modulus of the metallic wire is less than the initial modulus of the composite material;
b) the strain at which the stress-strain curve of the metallic wire starts to plateau is greater than the maximum strain of the composite material; and
c) the total area under the stress-strain curve of the metallic wire is at least ten times the total area under the stress-strain curve of the composite material; and
wherein the metallic wire is in a passive state.

21. The method of claim 20, wherein the initial modulus of the metallic wire is at least about 20% less than the initial modulus of the composite material.

22. The method of claim 20, wherein the metallic wire has an initial modulus equal to or greater than about 20 GPa.

23. The method of claim 20, wherein the metallic wire has an initial modulus equal to or less than about 35 GPa.

24. The method of claim 20, wherein the strain at which the stress-strain curve of the metallic wire starts to plateau is equal to or greater than about 0.5%.

25. The method of claim 20, wherein the plateau of the stress-strain curve of the metallic wire ends at a strain equal to or greater than about 4%.

26. The method of claim 20, wherein the plateau of the stress-strain curve of the metallic wire occurs at a stress that is less than the maximum stress of the composite material.

27. The method of claim 20, wherein the plateau of the stress-strain curve of the metallic wire occurs at a stress equal to or greater than about 100 MPa.

28. The method of claim 20, wherein the plateau of the stress-strain curve of the metallic wire occurs at a stress equal to or less than about 350 MPa.

29. The method of claim 20, wherein the total area under the stress-strain curve of the metallic wire is at least twelve times, for example at least fifteen times, the total area under the stress-strain curve of the composite material.

30. The method of claim 20, wherein the total energy absorbed by the metallic wire is equal to or greater than about 50 MJ/m³.

31. The method of claim 20, wherein the maximum strain of the metallic wire is equal to or greater than about 14%.

32. The method of claim 20, wherein the maximum stress of the stress-strain curve of the metallic wire is equal to or greater than about 1200 MPa.

33. The method of claim 20, wherein the metallic wire is a shape memory alloy (SMA) wires.

34. The method of claim 33, wherein each SMA wire is independently selected from the group consisting of Ti—Ni, Ti—Ni—Cu, Ti—Ni—Nb, Ti—Ni—Hf, Cu—Zn—Al, Cu—Al—Ni, Cu—Al—Zn—Mn, Cu—Al—Ni—Mn, Cu—Al—Mn—Ni, Fe—Mn—Si, Fe—Cr—Ni—Mn—Si—Co, Fe—Ni—Mn, Fe—Ni—C and Fe—Ni—Co—Ti alloys.

35. The method of claim 20, wherein the volume fraction of the metallic wire in the composite material ranges from about 2% to about 25%.

36. The method of claim 20, wherein the reinforcing fibres each independently have a tensile modulus in excess of 50 GPa, for example in excess of 200 GPa.

37. The method of claim 20, wherein the reinforcing fibres are each independently selected from carbon fibres, glass fibres, aramid fibres (e.g. Kevlar®), polyethylene fibres and boron fibres.

38. The method of claim 20, wherein the polymer matrix is formed from an epoxy resin, an acrylic resin, a polyester, a polyvinyl ester, a polyurethane, a phenolic resin, an amino resin or a furan resin.

39. A method for improving Use of metallic wires to improve the impact performance and/or penetration resistance of a composite material by providing metallic wires, the method further comprising:
a polymer matrix with reinforcing fibres embedded therein, wherein the metallic wires are embedded in the polymer matrix, wherein the metallic wires have a stress-strain curve such that:
a) the initial modulus of the metallic wire is less than the initial modulus of the composite material;
b) the strain at which the stress-strain curve of the metallic wire starts to plateau is greater than the maximum strain of the composite material; and
c) the total area under the stress-strain curve of the metallic wire is at least ten times the total area under the stress-strain curve of the composite material; and
wherein the metallic wires are in a passive state.

40. The method of claim 39, wherein the initial modulus of the metallic wires is at least about 20% less than the initial modulus of the composite material.

41. The method of claim 39, wherein the metallic wires have an initial modulus equal to or greater than about 20 GPa.

42. The method of claim 39, wherein the metallic wires have an initial modulus equal to or less than about 35 GPa.

43. The method of claim 39, wherein the strain at which the stress-strain curve of the metallic wires starts to plateau is equal to or greater than about 0.5%.

44. The method of claim 39, wherein the plateau of the stress-strain curve of the metallic wires ends at a strain equal to or greater than about 4%.

45. The method of claim 39, wherein the plateau of the stress-strain curve of the metallic wires occurs at a stress that is less than the maximum stress of the composite material.

46. The method of claim 39, wherein the plateau of the stress-strain curve of the metallic wires occurs at a stress equal to or greater than about 100 MPa.

47. The method of claim 39, wherein the plateau of the stress-strain curve of the metallic wires occurs at a stress equal to or less than about 350 MPa.

48. The method of claim 39, wherein the total area under the stress-strain curve of the metallic wires is at least twelve times, for example at least fifteen times, the total area under the stress-strain curve of the composite material.

49. The method of claim 39, wherein the total energy absorbed by the metallic wires is equal to or greater than about 50 MJ/m³.

50. The method of claim 39, wherein the maximum strain of the metallic wires is equal to or greater than about 14%.

51. The method of claim 39, wherein the maximum stress of the stress-strain curve of the metallic wires is equal to or greater than about 1200 MPa.

52. The method of claim 39, wherein the metallic wires are shape memory alloy (SMA) wires.

53. The method of claim 52, wherein each SMA wire is independently selected from the group consisting of Ti—Ni, Ti—Ni—Cu, Ti—Ni—Nb, Ti—Ni—Hf, Cu—Zn—Al, Cu—Al—Ni, Cu—Al—Zn—Mn, Cu—Al—Ni—Mn, Cu—Al—Mn—Ni, Fe—Mn—Si, Fe—Cr—Ni—Mn—Si—Co, Fe—Ni—Mn, Fe—Ni—C and Fe—Ni—Co—Ti alloys.

54. The method of claim 39, wherein the volume fraction of the metallic wires in the composite material ranges from about 2% to about 25%.

55. The method of claim 39, wherein the reinforcing fibres each independently have a tensile modulus in excess of 50 GPa, for example in excess of 200 GPa.

56. The method of claim 39, wherein the reinforcing fibres are each independently selected from carbon fibres, glass fibres, aramid fibres (e.g., Kevlar®), polyethylene fibres and boron fibres.

57. The method of claim 39, wherein the polymer matrix is formed from an epoxy resin, an acrylic resin, a polyester, a polyvinyl ester, a polyurethane, a phenolic resin, an amino resin or a furan resin.

58. An article comprising a composite material of claim 1.

59. The article of claim 58, wherein the article is an aircraft structural component.

60. The composite material of claim 1 structured for use as an aircraft structural component.
